(19) United States
(12) Patent Application Publication
(10) Pub. No.: US 2005/0084651 A1
(43) Pub. Date: Apr. 21, 2005

(54) Ornamental bunting secured at a center portion thereof

(75) Inventor: Abraham Damast, Great Neck, NY (US)

Correspondence Address: Dickstein Shapiro Morin & Oshinsky LLP, 41st Floor, 1177 Avenue of the Americas, New York, NY, 10036-2714, US

(73) Assignee: Commodore Manufacturing Corporation, Brooklyn, NY (US)

(21) Appl. No.: 10/686,868

(22) Filed: Oct. 15, 2003

(51) Int. Cl. B32B 3/04

(52) U.S. Cl. 428/121

(57) ABSTRACT

An ornamental bunting includes: a length of material folded to form a plurality of pleats, and a securing portion holding the plurality of pleats together at a point away from an end of the length of material so that opposite ends of the pleats can be fanned out relative to the securing portion.

### BACKGROUND OF THE INVENTION

1. Field of the Invention

This invention relates to decorative items, and more particularly, to an ornamental bunting formed from a length of material, an improved method of making an ornamental bunting, and an improved manner of securing the material making up the bunting.

2. Description of the Related Art

Ornamental buntings of the type typically seen at events associated with festivities, such as the Fourth of July or the World Series, are typically formed by folding lengthwise generally rectangular soft flexible material, such as a fabric, usually decorated brightly, into pleats and securing the pleats together at one end to allow the other end to be spread out in a fan shape.

FIG. 1 is illustrative of a bunting formed in the conventional manner. The conventional bunting 10 is formed from a rectangular length of material 20 folded to form a plurality of pleats 30. One of the two long sides 32 of the length of material is held in a gathered condition, as referenced by numeral 30, for example, by a ring 36 threading together apertures (not visible in the figure) formed in the long side to be so gathered. Other prior art methods involved stitching the gathered end pleats together. By means of the ring 36, or other known method of attachment, the pleats at one end of the length of material are held in proximity to one another. The opposite side 32 of the length of material is allowed to spread to form a substantially semi-circular perimeter so that the bunting 10 as a whole is generally fan shaped. The pleats 30 are formed in the length of material 20 by a series of alternating folds, as is well known.

While generally good for their intended purpose, only a limited number of shapes can be made by the bunting secured in this manner, due at least in part to the fact that such buntings are secured at the end portion of the material, so that the fanning out only occurs at the end opposite from the gathered end.

Thus, there exists a need for a bunting that by its structure would allow for a plurality of shapes to be effected, while still having a low cost of manufacture and a pleasing appearance.

### SUMMARY OF THE INVENTION

It is an object of the invention to provide an article and a method for forming and securing an ornamental bunting that allows the ornamental bunting to be manufactured conveniently and inexpensively.

It is a further object of the invention to provide an ornamental bunting that has a pleasing and neat appearance and that may be expanded into a plurality of shapes.

According to an aspect of the invention, there is provided an ornamental bunting, including a length of material folded to form a plurality of pleats, and a securing means to the pleats of the length of material in a gathered condition at a centrally located portion along the length of material.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 is a top plan view of a conventional ornamental bunting;

FIG. 2 is a top plan view of an ornamental bunting formed in accordance with the present invention in a substantially non-expanded condition;

FIG. 3 is a perspective view of the ornamental bunting in accordance with the present invention, in an unexpanded state;

FIG. 4 is a top plan view of the ornamental bunting of the present application, fully expanded to a circular pattern;

FIG. 5 is a top plan view of the ornamental bunting of the present invention with pleats secured so as to form a semi-circular shape;

FIG. 6 is a top plan view of the ornamental bunting of the present invention partially expanded so as to form a bow-tie shape;

FIG. 7 is a top plan view of the ornamental bunting of the present invention partially expanded so as to form a mushroom shape;

FIG. 8 is a top plan view of the ornamental bunting of the present invention in a folded state suitable for storage and/or hanging for display.

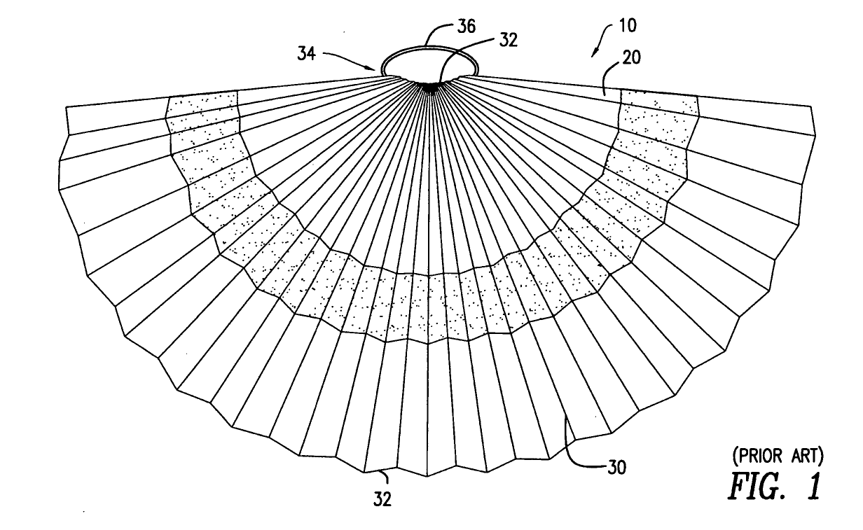

### DESCRIPTION OF THE PREFERRED EMBODIMENTS

An ornamental bunting constructed in accordance with the principles of the present invention is shown in the figures. In this embodiment, a generally rectangular sheet (other shapes can be used) is formed of a preferably soft flexible material, such as a fabric, which has been folded lengthwise so as to form plural pleats. The pleats are brought together and substantially permanently secured, for example by stitching, at a point approximately halfway down the length of the material. The sheet of material used for the bunting may be of unitary construction, i.e., formed of a single piece of material, or may be a composite, formed of more than one sheet of material sewn together to form the fabric of the bunting. As will become clear in view of the detailed description to follow, such a composite may be useful, for example, in imparting decorative styling to the bunting by combining portions of material having different patterns thereon.

The bunting so formed may be expanded, from each side of the gathered center portion, in a fan-like manner to form different shapes, including for example, a circle, a fan shape, or a mushroom shape. In addition, fasteners preferably are preferably provided along the edges of the fabric, or other flexible material, to maintain the bunting in a desired configuration by mating a first fastener with a counterpart fastener on another fabric edge. For example, two or four fabric edges may be secured together to retain a fan, mushroom or other shape. In addition, a tab may be provided, secured at an edge of the fabric, that allows for the bunting to be hung for display, preferably in a folded condition.

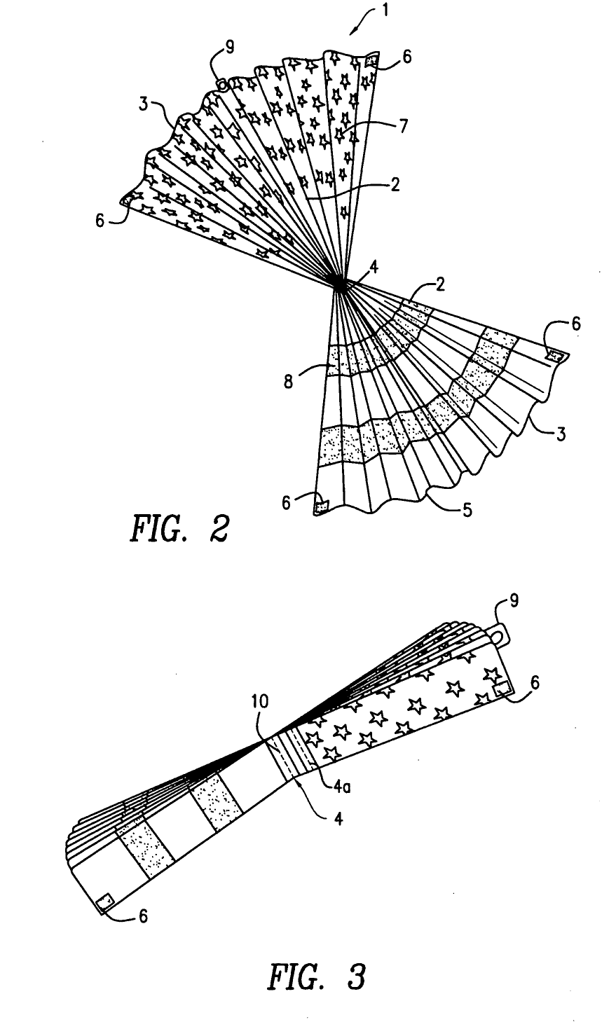

As can be seen in FIGS. 2 and 3, the bunting 1 of the present invention is formed by securing a folded flexible material 2 having opposite sides 3. As in the conventional bunting, the generally rectangular bunting material 2 is folded lengthwise multiple times so as to form plural pleats 5. The pleats 5 are formed in the length of material 2 by a series of alternating folds, as is well known. However, unlike the conventional bunting, the pleats are securely gathered together by a securing portion 4 at a point away from either end of the material 2 and preferably at a point approximately midway along the length of the material 2. By way of example, the securing portion may be stitching. The material 2 may be any flexible material capable of being folded into pleats. An example of such a suitable material would be a fabric, either natural or synthetic, or a combination thereof.

The bunting material 2 may be formed of a single piece of material, or it may be a composite material, consisting of sewn-together or otherwise attached sheets of fabric, for example, to provide for multiple decorative patterns in a single bunting. In the case of a composite, reference to the length of the bunting material will be a reference to the length of the composite material, which may have component different fabrics, for example.

In a preferred embodiment, and as can best be seen in FIG. 3, the stitching 10 constitutes the securing portion 4 and is secured along a line perpendicular to the length of the material and sewn across the width of the pleat to securely and substantially permanently gather all of the pleats together at the location of the stitching 10, in the embodiment shown, at a point about halfway down the length of the material. The stitching 10 provides for a very tight, secure and substantially permanent grip on the material, ensuring that the bunting, once manufactured, will maintain its overall structure.

FIG. 3 is an example in which the different decorative patterns of the bunting are provided by use of a composite material. As can be seen in FIG. 3, seam 4a shows the location at which a fabric having a star pattern is connected with a slightly longer fabric having a striped pattern. The entire composite material once sewn together, constitutes the “length of material” of the bunting. As can be seen from the picture, in this case the pleats are secured at a point halfway down the length of the composite material. Of course a pattern can be made in any known manner, including dyeing, and the process of applying even the most complicated patterns is not limited to the use of composite materials.

In addition, the effect of the present invention will be maintained if the securing portion is provided at a point that is not exactly at the midway of the length of material, as long it is not provided too close to one end, which would have the effect of limiting the shapes that could be formed.

In accordance with a preferred embodiment of the present invention, the bunting 1 includes ornamentation 6 and 7. In the illustrated example, ornamentation 6 is a field of stars, such as the stars in the American flag, while ornamentation 7 is a set of stripes, for example red stripes on a white background, as in the American flag. Of course, the present invention is not limited to this, or any, ornamentation scheme.

Securing portions 6 are provided at end points along the sides of the material. These securing portions allow corners of the material to be secured together to allow for formation of certain decorative shapes, such as those to be discussed below. Preferably, the securing portions are matched pairs of Velcro or similar material. Alternatively, simple holes with grommets may be used. In such a case, the corners may be affixed in proximity to one another by using nails or other means to secure the bunting, spread in any desired shape, to a wall or other backing, or, for example, by loop fasteners, or the like, looping through the grommets to hold the opposing comers together. A tab 9 is preferably provided affixed to an end 3. The tab 9 is used, for example, to hang the bunting for display in a store. In a preferred embodiment, the tab is made of a clear material, such as plastic, and is affixed to a pleat with an adhesive.

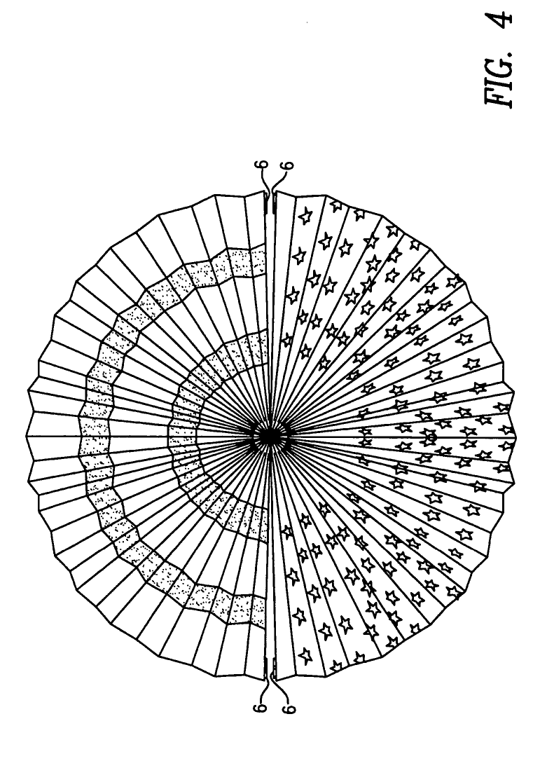

When the bunting is formed in this manner, the opposite sides 3 of the length of material can spread allowing the bunting to form any number of shapes. For example, if each side is fully spread out, a pair of substantially semi-circular perimeters can be formed, resulting in a circular or starburst pattern. An example of a fully spread bunting is shown in FIG. 4. As can be seen in that figure, because the material is secured at a central location, the radius of the thus-formed circle is equal to the distance from the stitching 10 to the end 3 of the material. To maintain the circular appearance, opposing securing portions 6 are connected together to temporarily affix opposite corners to one another.

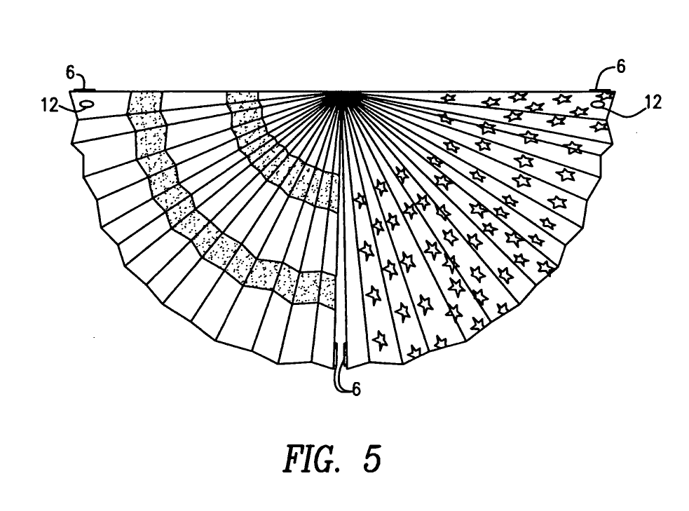

FIGS. 5 through 7 show non-limiting examples of various configurations possible due to the advantageous design of the present invention.

As shown in FIG. 5, a semicircular bunting may be formed by affixing opposite comers together with fasteners 6 while, for example, maintain the other two comers so as to form a straight top edge, as shown in the figure. The corners may be affixed to a wall or other backing surface by means of nails, tacks, or the like through holes 12, which, in a preferred embodiment are provided at corner portions of the bunting for this purpose.

In order to provide a decorative appearance, the length of material 2 may be decorated in any desired manner. It may also include any desired wording. It should be understood that the bunting need not be decorated in the manner described above, or at all and the above-described decorations are for illustrative purposes only.

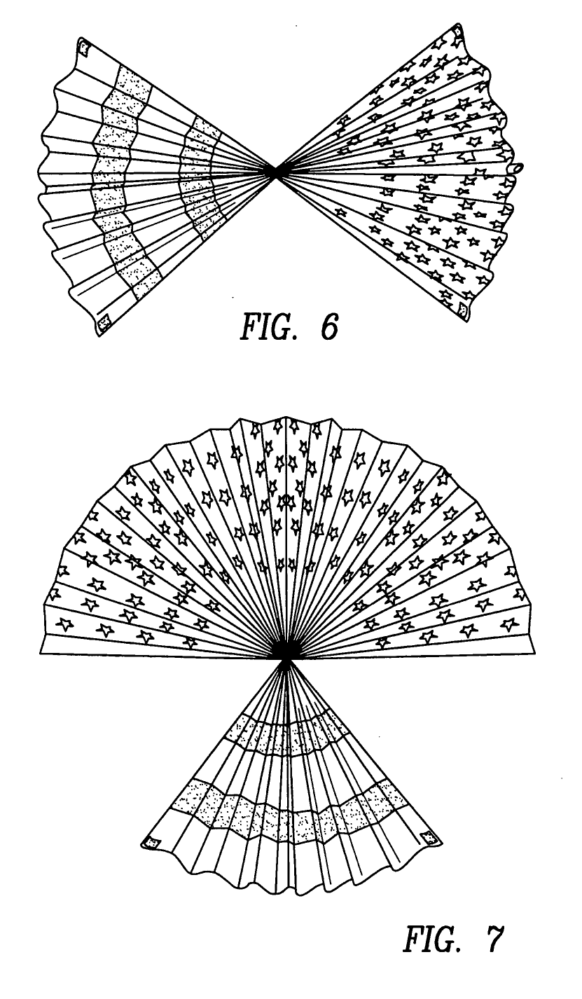

FIG. 6 shows the bunting of the present invention spread out to form a bow tie shape. As can be seen from the figure, a bow tie shape is formed by partially fanning out each end of the material in relation to the gathered central portion.

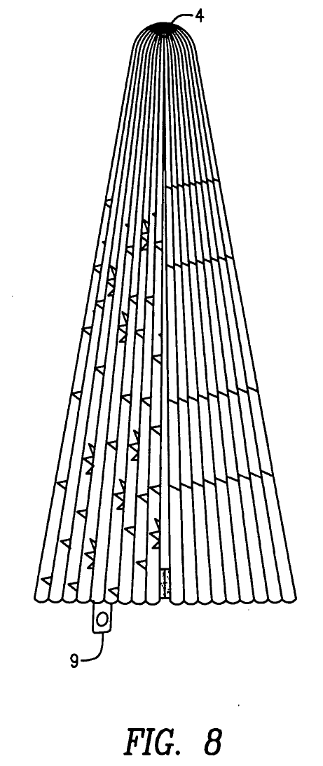

FIG. 7 shows the bunting of the present invention spread out to form a mushroom shape. As can be seen from the figure, a mushroom shape is formed by fanning out one half of the bunting to a semicircle, while only partially fanning out the other portion. It will be understood that an unlimited combination of shapes can be achieved by varying the amount of fanning of each portion of the bunting in accordance with the present invention and the invention is in no way limited to the illustrated configurations.

FIG. 8 illustrates a preferred manner of folding the bunting of the present invention for display and/or storage thereof. As shown in the figure, the bunting is folded at the central portion thereof and the ends are brought together and secured by fasteners 6. Once the ends are fastened, the bunting can be hung on a store display, for example, by means of the tab 9. Optionally, plastic wrapping can be used to more tightly bundle the two halves of the bunting together for display.

In addition to the shapes shown in the illustrative figures, as will be understood, by changing the shape of the material itself, different resultant shapes can be attained, such as a star, a snowflake, oval, hearts, or other shapes. In addition, by affixing multiple layers of sheets of material, for example sheets of different lengths, a starburst, for example, can be formed.

Various changes to the foregoing article of manufacture may be introduced without departing from spirit and scope of the present invention. The above-described embodiments are strictly illustrative in nature and do not limit the invention, the scope of which is defined in the following claims.

1. An ornamental bunting, comprising:
a length of material folded to form a plurality of pleats; and
a securing portion holding the plurality of pleats together at a point away from an end of the length of material so that opposite ends of the pleats can be fanned out relative to the securing portion.

2. The ornamental bunting according to claim 1, wherein the securing portion holds the plurality of pleats together at a point approximately midway between the opposite ends of the pleats.

3. The ornamental bunting according to claim 2, wherein the securing portion comprises stitching arranged in a direction perpendicular to the lengthwise direction of the material.

4. The ornamental bunting according to claim 3, wherein the length of material is formed as a composite of more than one sheet of material.

5. The ornamental bunting according to claim 1, further comprising a tab having a hanger hole connected to the material.

6. The ornamental bunting according to claim 1, further comprising fasteners, provided in proximity to corners of the length of material, the fasteners allowing two or more corners of the material to be affixed to one another.

7. The ornamental bunting according to claim 6, wherein the fasteners comprise Velcro strips

8. An ornamental bunting, the bunting comprising:
a length of material folded to form a plurality of pleats; and
means for securing the pleats in a gathered condition at a location approximately midway along the length of the material.

9. The ornamental bunting according to claim 8, wherein the securing means comprises stitching arranged in a direction perpendicular to a lengthwise direction of the folded material.

10. The ornamental bunting according to claim 9, wherein the length of material is formed as a composite of more than one sheet of material.

11. The ornamental bunting according to claim 8, further comprising a tab having a hanger hole connected to the material.

12. The ornamental bunting according to claim 8, further comprising fasteners, provided in proximity to corners of said sheet of material, the fasteners allowing two or more corners of the material to be affixed to one another.

13. The ornamental bunting according to claim 12, wherein the fasteners comprise Velcro strips.

14. A method of forming an ornamental bunting, the method comprising:
folding a length of material to form a plurality of pleats; and
securing the pleats in a gathered condition at a location approximately midway along the length of the material.
